(19) United States
(12) Patent Application Publication
(10) Pub. No.: US 2015/0172619 A1
(43) Pub. Date: Jun. 18, 2015

(54) STORAGE MEDIUM, REPRODUCING APPARATUS AND METHOD FOR RECORDING AND PLAYING IMAGE DATA

(71) Applicants: SAMSUNG ELECTRONICS CO., LTD., Suwon-si (KR); Gangneung-wonju National University Industry Academy Cooperation Group, Gangneung-si (KR)

(72) Inventors: Jong-ho YANG, Yongin-si (KR); Bong-gil BAK, Suwon-si (KR); Sung-wook PARK, Gangneung-si (KR)

(73) Assignees: SAMSUNG ELECTRONICS CO., LTD., Suwon-si (KR); Gangneung-wonju National University Industry Academy Cooperation Group, Gangneung-si (KR)

(21) Appl. No.: 14/568,403

(22) Filed: Dec. 12, 2014

Related U.S. Application Data
(60) Provisional application No. 61/915,592, filed on Dec. 13, 2013.

(30) Foreign Application Priority Data
Jul. 24, 2014 (KR) 10-2014-0093820

(51) Int. Cl. H04N 9/804; H04N 5/85

(52) U.S. Cl. CPC H04N 9/8042; H04N 5/85

(57) ABSTRACT

A storage medium, a reproducing apparatus and a method for recording and playing image data are provided. The method for storing the image data includes encoding image data including at least one group of pictures (GOP), and storing the encoded image data and additional information for the image data, wherein the at least one GOP includes an I-frame, a plurality of P-frames and a plurality of B-frames and wherein the encoding the image data includes encoding the at least one GOP in order of the I-frame, the plurality of P-frames and the plurality of B-frames.

### CROSS-REFERENCE TO RELATED APPLICATIONS

This application claims priority from Korean Patent Application No. 10-2014-0093820, filed on Jul. 24, 2014 in the Korean Intellectual Property Office, and U.S. Provisional Application No. 61/915,592 filed on Dec. 13, 2013 in the United States Patent and Trademark Office, the disclosures of which are incorporated herein in their entireties by reference.

### BACKGROUND

1. Field

Apparatuses and methods consistent with exemplary embodiments relate to a storage medium, a reproducing apparatus and a method for storing and replaying image data, and, more particularly, to a storage medium, a reproducing apparatus and a method of storing and replaying image data in order to replay the image data at a high-speed and at multiple data rates.

2. Description of the Related Art

In the related art, a reproducing apparatus, such as a digital video disc (DVD) player, a Blu-ray disc player, etc. can reproduce video images at a high data rate as well as at a normal data rate.

For example, when reproducing video images based on a group of pictures (GOP) having 24 frames, when a user enters a high-speed replay command, the reproducing apparatus chooses and then reproduces only an I-frame from a plurality of frames constituting each GOP. Therefore, it displays the video images in a high-speed replay of a ×24 data rate.

However, because such a data rate in the conventional high-speed replay method is very fast, in a case where a user watches video images in a high-speed replay, the user may not be able to correctly understand the whole flow of the video images. Also, it may be difficult for the user to search for a particular portion of the video images during the high-speed replay.

### SUMMARY

Exemplary embodiments provide a method of enabling the high-speed replay of video image at multiple data rates in a reproducing apparatus.

According to an aspect of an exemplary embodiment, there is provided a method of storing image data, the method including: encoding image data comprising at least one group of pictures (GOP); and storing the encoded image data and additional information for the image data. The at least one GOP includes an intra-frame (I-frame), a plurality of predictive-frames (P-frames) and a plurality of bi-directionally predictive frames (B-frames); and the encoding the image data comprises encoding in order of the I-frame, the plurality of P-frames and the plurality of B-frames.

The additional information may include location information of the I-frame, size information of the I-frame, size information of the plurality of P-frames, and structure information of GOP.

In response to there being a reference B-frame, which serves as a reference frame of the other B-frames, in the plurality of B-frames, the encoding may include encoding the reference B-frame to be positioned before the other B-frames of the plurality of B-frames.

The additional information may include location information of the I-frame, size information of the I-frame, size information of the plurality of P-frames, size information of the reference B-frame, and structure information of GOP.

According to an aspect of another exemplary embodiment, there is provided a method of reproducing image data, the method including: receiving image data including at least one group of pictures (GOP), wherein the at least one GOP is encoded in an order of an intra-frame (I-frame), a plurality of predictive-frames (P-frames) and a plurality of bi-directionally predictive frames (B-frames); in response to a high-speed replay command, decoding at least one of the I-frame and the plurality of P-frames according to a data rate which corresponds to the high-speed replay command; and reproducing the decoded I-frame and the plurality of decoded P-frames.

The decoding may include decoding at least one of the I-frame and the plurality of P-frames according to a data rate, which corresponds to the high-speed replay command based on additional information for the encoded image data. The additional information may include location information of the I-frame, size information of the I-frame, size information of the plurality of P-frames, and structure information of GOP.

The decoding may include, in response to a high-speed replay command corresponding to a high data rate being input, decoding only the I-frame based on the location information of the I-frame and the size information of the I-frame.

The decoding may include, in response to a high-speed replay command corresponding to a low data rate, decoding the I-frame and the plurality of P-frames based on the location information of the I-frame and the size information of the I-frame and size information of the plurality of P-frames.

The decoding may include, in response to a high-speed replay command corresponding to an intermediate data rate, decoding the I-frame and a P-frame positioned after the I-frame based on the location information of the I-frame and the size information of the I-frame and size information of the P-frame positioned after the I-frame.

According to an aspect of another exemplary embodiment, there is provided a storage medium configured to store image data, which includes: an information storage area configured to store additional information for the image data; and a data area configured to store image data comprising at least one group of pictures (GOP). Each of the at least one GOP includes an intra-frame (I-frame), a plurality of predictive-frames (P-frames) and a plurality of bi-directionally predictive frames (B-frames) and is encoded in an order of the I-frame, the plurality of P-frames and the plurality of B-frames.

The additional information may include location information of the I-frame, size information of the I-frame, size information of the plurality of P-frames, and structure information of the GOP.

In response to there being a reference B-frame, which serves as a reference frame of the other B-frames, in the plurality of B-frames, the reference B-frame may be encoded to be positioned before the other B-frames of the plurality of B-frames.

The additional information may include location information of the I-frame, size information of the I-frame, size information of the plurality of P-frames, size information of the reference B-frame, and structure information of GOP.

According to an aspect of another exemplary embodiment, there is provided an apparatus of reproducing image data, the apparatus including: an inputter configured to receive image data whose at least one group of pictures (GOP) which are encoded in an order of an intra-frame (I-frame), a plurality of predictive-frames (P-frames) and a plurality of bi-directionally predictive frames (B-frames); a decoder configured to decode the encoded image data; a display configured to display the decoded image data; and a controller configured to control the decoder to decode at least one of the I-frame and the plurality of P-frames according to any data rate corresponding to the high-speed replay command and control the display to display image data with respect to at least one of the decoded I-frame and the plurality of decoded P-frames, respectively, in response to the high-speed replay command.

The controller may control the decoder to decode at least one of the I-frame and the plurality of P-frames according to a data rate which corresponds to the high-speed replay command based on additional information for the encoded image data. The additional information may include location information of the I-frame, size information of the I-frame, size information of the plurality of P-frames, and structure information of the GOP.

The controller may control the decoder to decode only the I-frame based on the location information of the I-frame and the size information of the I-frame, in response to a high-speed replay command corresponding to a high data rate.

The controller may control the decoder to decode the I-frame and the plurality of P-frames based on the location information of the I-frame and the size information of the I-frame, and the size information of the plurality of P-frames, in response to a high-speed replay command corresponding to a low data rate.

The controller may control the decoder to decode the I-frame and a P-frame positioned after the I-frame based on the location information of the I-frame and the size information of the I-frame, and size information of the P-frame positioned after the I-frame, in response to a high-speed replay command corresponding to an intermediate data rate.

The apparatus may further include: a first buffer configured to temporarily store frames outputted from the inputter; and a second buffer configured to temporarily store frames outputted from the decoder and output the temporarily stored frames to the display. And the controller may control the decoder to perform the decoding, according to a priority based on identification information for each of the frames which are temporarily stored in the first buffer.

The apparatus may further include: a first buffer configured to temporarily store frames which are outputted from the inputter; and a second buffer configured to temporarily store frames which are outputted from the decoder and output the temporarily stored frames to the display. The controller may control the second buffer to display the frames, according to a priority based on identification information for each of the frames temporarily stored in the second buffer.

According to the above exemplary embodiments, a reproducing apparatus may perform high-speed replay for image data at various data rates.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a storage medium according to an exemplary embodiment;

FIG. 2 is an exemplary diagram illustrating respective zones constituting a blue-ray disc according to an exemplary embodiment;

FIG. 3 is a block diagram illustrating a reproducing apparatus for reproducing image data according to an exemplary embodiment;

FIG. 4 is an exemplary diagram illustrating encoding of image data on a group of pictures (GOP) basis according to an exemplary embodiment;

FIG. 5 is an exemplary diagram illustrating additional information of encoded image data according to an exemplary embodiment;

FIG. 6 is an exemplary diagram illustrating encoding image data on a GOP basis according to another exemplary embodiment;

FIG. 7 is an exemplary diagram illustrating performing a high-speed replay at multiple data rates in a reproducing apparatus according to another exemplary embodiment;

FIG. 8 is a first exemplary diagram illustrating reproducing encoded image data in a reproducing apparatus according to an exemplary embodiment;

FIG. 9 is a second exemplary diagram illustrating reproducing encoded image data in a reproducing apparatus according to another exemplary embodiment;

FIG. 10 is a flowchart illustrating a method for storing image data in a storage medium according to an exemplary embodiment; and

FIG. 11 is a flowchart illustrating a method for reproducing image data in a reproducing apparatus according to an exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for same elements when they are depicted in different drawings. The matters defined in the description, such as detailed construction and elements, are provided to assist in a comprehensive understanding of exemplary embodiments. Thus, it is apparent that the exemplary embodiments can be carried out without those specifically defined matters. Also, functions or elements known in the related art are not described in detail since they would obscure the exemplary embodiments with unnecessary detail.

Hereinafter, exemplary embodiments of the present inventive concept are described in detail with reference to the accompanying drawings.

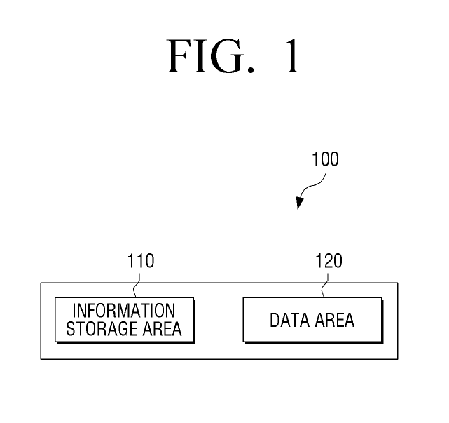

FIG. 1 is a block diagram illustrating a storage medium according to an exemplary embodiment.

As shown in FIG. 1, the storage medium 100 may include an information storage area 110 and a data area 120.

The information storage area 110 stores additional information for image data. The information storage area 110 stores additional information for image data. Here, each of at least one group of pictures (GOP) includes an intra-frame (I-frame), a plurality of predictive-frames (P-frames) and a plurality of bi-directionally predictive frames (B-frames), and a plurality of frames included in each of at least one GOP may be encoded in order of an I-frame, the plurality of P-frames and the plurality of B-frames and then stored in the data area 120

The I-frame is a picture frame which may be coded by using only pixels within the frame without coding with a motion compensated estimation relative to any other frames. And, the P-frame is a one-way predictive frame which may be coded with a motion compensated estimation between frames with reference to a preceding I-frame and a preceding P-frame. Finally, the B-frame is a two-way predictive frame which may be coded with a motion compensated estimation in a forward and a backward direction and in both of the directions with reference to an I-frame or a P-frame positioned before the B-frame in time or with reference to an I-frame or a P-frame located before and after the B-frame. A B-frame exhibits the most noticeable compression efficiency among an I-frame, a P-frame and the B-frame. Each GOP including an I-frame, a plurality of P-frames and a plurality of B-frames means that a plurality of frames are combined in various patterns, but in a regular order of I-picture, P-picture(s) and B-picture(s) in a single group.

The additional information may include location information of an I-frame, size information of the I-frame and a plurality of P-frames, and structure information of the GOP. Here, the location information of the I-frame is start information which indicates where an I-frame should start being reproduced, and the structure information of the GOP may be information for the number of B-frames between an I-frame and P-frame or the number of B-frames between two P-frames.

A reproducing apparatus 300, which will be described in more detail below, may begin reproduction from an I-frame among the plurality of frames included in a GOP based on the location information of the I-frame included in the additional information, and may perform a high-speed replay of image data at a certain data rate corresponding to a high-speed replay command based on the size information of the I-frame and a plurality of P-frames. In addition, the reproducing apparatus 300 may determine a low data rate based on the structure information of the GOP as included in the additional information.

As described above, a B-frame which references an I-frame or a P-frame positioned preceding the B-frame or references an I-frame or a P-frame located before or after the B-frame may reference a specific B-frame under a predetermined condition. Here, the specific B-frame is a reference B-frame, and in the case where there is a reference B-frame, each of the at least one GOP may be encoded in order of an I-frame, a plurality of P-frames, the reference B-frame, and the remaining B-frames and then stored in the data area 120.

As mentioned above, when there is a reference B-frame, the additional information including location information of the I-frame, size information of the I-frame and a plurality of P-frames, and structure information of GOP may further include size information of the reference B-frame.

The storage medium 100 including the information storage area 110 and the data area 120 for storing such additional information and image data, respectively, may be a blue-ray disc (BD) which has at least one layer, according to an exemplary embodiment. However, the exemplary embodiments are not limited thereto, and the storage medium 100 according to the exemplary embodiments may be any one of various optical discs such as a compact disc (CD), a digital versatile disc (DVD), a blue-ray ROM disc (BD-ROM disc), etc. Hereinafter, a case where the storage medium 100, according to an exemplary embodiment, is implemented by a blue-ray disc for storing the aforementioned additional information and image data, is more particularly described.

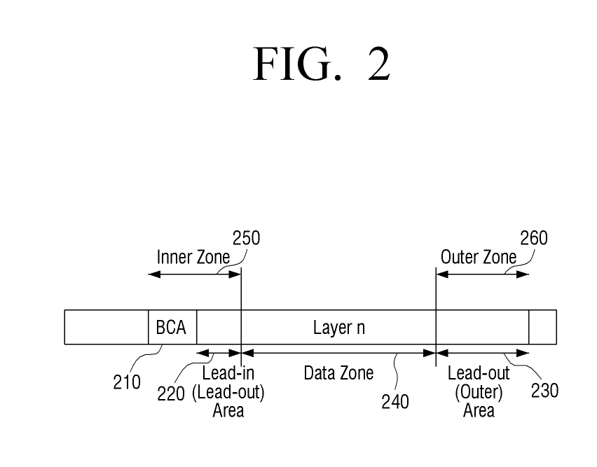

FIG. 2 is an exemplary diagram illustrating respective zones constituting the blue-ray disc according to an exemplary embodiment.

As shown in FIG. 2, the blue-ray disc includes an inner zone 250, a data zone 240 and an outer zone 260.

In this case, the inner zone 250 may include a burst cutting area (BCA) 210, in which a media ID for a copyright, etc. is recorded, and a lead-in area 220. According to blue-ray ROM format standards, the BCA 210 is in a radius of 21.0 mm to 22.2 mm of the blue-ray disc. The lead-in area 220 includes permanent information control (PIC) data in which information for an optical disc is recorded. According to blue-ray ROM format standards, the PIC area is in a radius of 22.5 mm to 23.2 mm of the blue-ray disc. The information for the blue-ray disc which is stored in the PIC area is known to those skilled in the art, and, thus the detailed description thereof is omitted herein.

Such a PIC area may be the information storage area 110 as described above. Therefore, the aforementioned additional information may be stored in a preliminary area of the PIC area storing the information for the blue-ray disc.

A lead-out area 230 is within the outer zone 260 and a data zone 240 is between the lead-in area 220 and the lead-out area 230. The data zone 240 is the data area 120 of the storage medium 100 as described above, and may store image data including at least one GOP which has been encoded in order an I-frame, a plurality of P-frames and a plurality of B-frames.

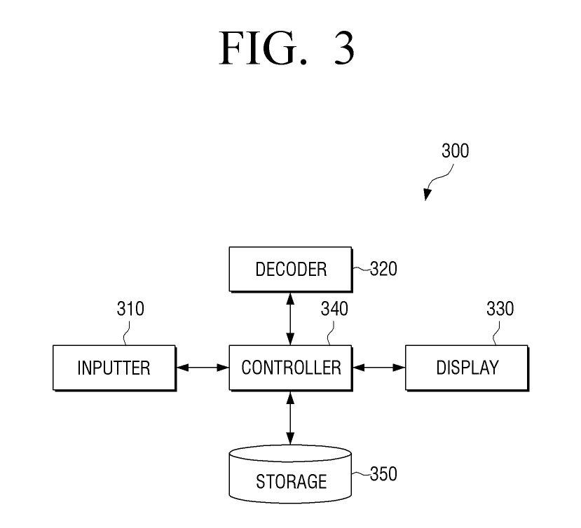

FIG. 3 is a block diagram illustrating the reproducing apparatus for reproducing image data according to an exemplary embodiment.

As shown in FIG. 3, the reproducing apparatus 300 includes an inputter 310, a decoder 320, a display 330, a controller 340 and a storage 350.

The inputter 310 receives image data, which has at least one GOP which is encoded in an order of an I-frame, a plurality of P-frames and a plurality of B-frames, and the decoder 320 decodes image data received by the inputter 310. The display 330 displays the image data decoded by the decoder 320.

The controller 340 controls operations for the respective configurations constituting the reproducing apparatus 300. In particular, when a high-speed replay command is input, the controller 340 controls the decoder 320 to decode at least one of the I-frame and the plurality of P-frames as received by the inputter 310 according to any data rate corresponding to the high-speed replay command which was input.

When the at least one of the I-frame and the plurality of P-frames is decoded by the decoder 320 according to such a control command, the controller 340 controls the display 330 to display at least one of the decoded I-frame and the plurality of decoded P-frames. As a result, the display 330 may replay image data at the data rate corresponding to the user's high-speed replay command by displaying at least one of the decoded I-frame and the plurality of decoded P-frames.

The controller 340 may control the decoder 320 to decode at least one of the I-frame and the plurality of P-frames according to a data rate corresponding to the high-speed replay command based on additional information for the encoded image data. Here, the additional information may include location information of the I-frame for at least one of respective GOPs, size information of the I-frame and the plurality of P-frames, and structure information of the GOP with respect to each of at least one GOP. In an exemplary embodiment, the location information of the I-frame is start information showing where the I-frame begins to be reproduced, and the structure information of the GOP may be information for the number of B-frames between the I-frame and a P-frame or the number of B-frames between two P-frames.

Such additional information along with image data encoded in the order of the I-frame, the plurality of P-frames and the plurality of B-frames may be stored in the storage 350. In an exemplary embodiment, the storage 350, which is the storage medium 100 as described in FIG. 1, may be a blue-ray disc.

Therefore, the controller 340 controls the decoder 320 to decode at least one of the I-frame and the plurality of P-frames based on the additional information with respect to the corresponding image data stored in the storage 350. As a result, the decoder 320 decodes the I-frame of the plurality of frames or the I-frame and at least one P-frame of the plurality of P-frames as received by the inputter 310. The display 330 may perform the high-speed replay of the content at the data rate corresponding to the user's high-speed replay command by displaying only the decoded frame among the plurality of frames.

According to an exemplary embodiment, when the high-speed replay command corresponding to the high data rate is input, the controller 340 controls the decoder 320 to decode only the I-frame based on the location information of the I-frame and the size information of the I-frame, with reference to the additional information. Thus the decoder 320 decodes only the I-frame among the plurality of frames on a GOP basis as received by the inputter 310. However, the exemplary embodiments are not limited thereto, and when the high-speed replay command corresponding to a high data rate is input, the controller 340 outputs only the I-frame to the inputter 310 based on the location information of the I-frame and the size information of the I-frame, with reference to the additional information. As a result, the inputter 310 may receive only the I-frame among the plurality of frames in each GOP and the decoder 320 may decode only the I-frame in each GOP as received by the inputter 310. Afterwards, the display 330 may perform the high-speed replay corresponding to the high data rate by displaying image data with respect to only the I-frame in each GOP as decoded by the decoder 320.

When the high-speed replay command corresponding to a low data rate is input, the controller 340 controls the decoder 320 to decode the I-frame and the plurality of P-frames based on the location information of the I-frame and the size information of the I-frame and the plurality of P-frames, with reference to the additional information. Accordingly, the decoder 320 decodes only the I-frame and the plurality of P-frames except for the B-frames among the plurality of frames based on the GOP as received by the inputter 310. However, the exemplary embodiments are not limited thereto and when the high-speed replay command corresponding to a low data rate is input, the controller 340 outputs the I-frame and the plurality of P-frames to the inputter 310, with reference to the additional information. As a result, the inputter 310 may receive the I-frame and the plurality of P-frames except for the B-frames among the plurality of frames in each GOP and the decoder 320 may decode the I-frame and the plurality of P-frames in each GOP as received by the inputter 310. Afterwards, the display 330 may perform the high-speed replay corresponding to the low data rate by displaying the image data with respect to only the I-frame and the plurality of P-frames in each GOP as decoded by the decoder 320.

When the high-speed replay command corresponding to an intermediate data rate between the high and the low data rate is input, the controller 320 controls the decoder 320 to decode only the I-frame and the P-frame positioned after the I-frame based on the location information of the I-frame and the size information of the I-frame and the P-frame, positioned after the I-frame, among the plurality of P-frames, with reference to the additional information. Accordingly, the decoder 320 may decode only the I-frame and the P-frame positioned after the I-frame among the plurality of frames as received by the inputter 310. However, the exemplary embodiments are not limited thereto and when the high-speed replay command corresponding to an intermediate data rate is input, the controller 340 may output only the I-frame and P-frames positioned after the I-frame to the inputter 310, with reference to the additional information. As a result, the inputter 310 may receive only the I-frame and the P-frame positioned after the I-frame among the plurality of frames in each GOP and the decoder 320 may decode only the I-frame and the P-frame positioned after the I-frame in each GOP as received by the inputter 310. Afterwards, the display 330 may perform the high-speed replay corresponding to the intermediate data rate by displaying the image data with respect to the I-frame and the P-frame poisoned after the I-frame, as decoded by the decoder 320.

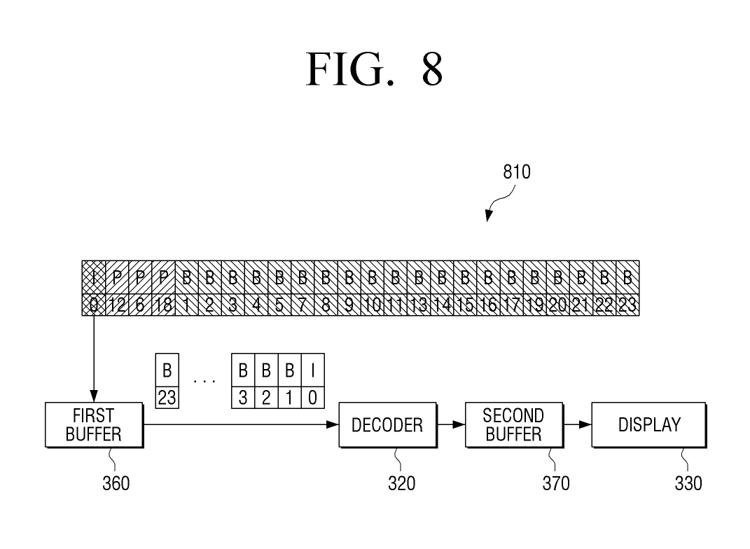

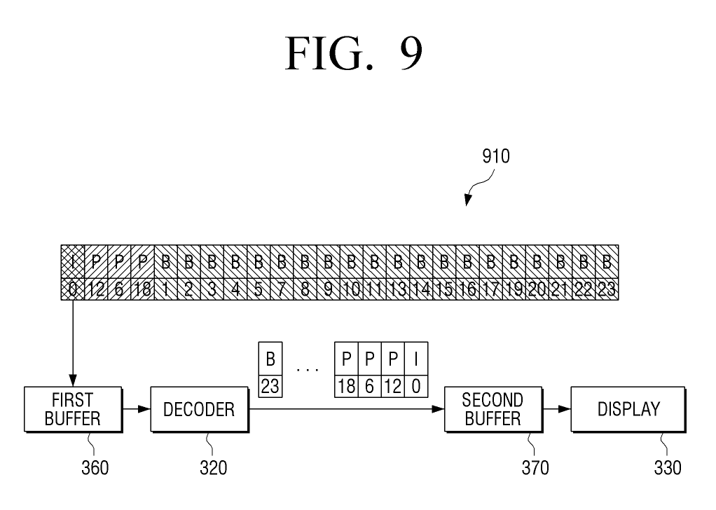

The reproducing apparatus 300 according to the exemplary embodiments may include a first buffer, which is described in more detail in FIGS. 8 and 9, for temporarily storing the plurality of frames based on a GOP as input into the inputter 310 and a second buffer for temporarily storing frames outputted from the decoder 320. Hence, the controller 340 may minimize the workload of at least one of the first and second buffers according to an exemplary embodiment as discussed below.

In order to minimize the workload on the second buffer, the controller 340 may control the decoder 320 to perform the decoding from a frame having a priority based on identification information for each frame temporarily stored in the first buffer. Pursuant to such control instructions, the decoder 320 performs the decoding at a frame having the priority among the plurality of frames temporarily stored in the first buffer and then outputs the decoded frame to the second buffer. Thus the display 330 may minimize workload on the second buffer by displaying the image data with respect to the decoded frames in the same order as that temporarily stored in the second buffer.

In order to minimize the workload on the first buffer, the decoder 320 performs the decoding according to the frame order as temporarily stored in the first buffer and then outputs the frames to the second buffer. As a result, the second buffer may store the decoded frames in the same order as when they were temporarily stored in the first buffer. Accordingly, the controller 340 controls the second buffer to display the decoded frames from a frame corresponding to the priority based on the identification information for each frame temporarily stored in the second buffer. Pursuant to such control instructions, the second buffer may output the plurality of decoded and temporarily stored frames from a frame corresponding to the priority to the display 330 and hence may minimize the workloads of the first buffer.

The respective configurations of the reproducing apparatus 300 for reproducing image data according to the exemplary embodiments have been described in detail. Hereinafter, a method for performing a high-speed replay of image data according to various exemplary embodiments will be described in detail.

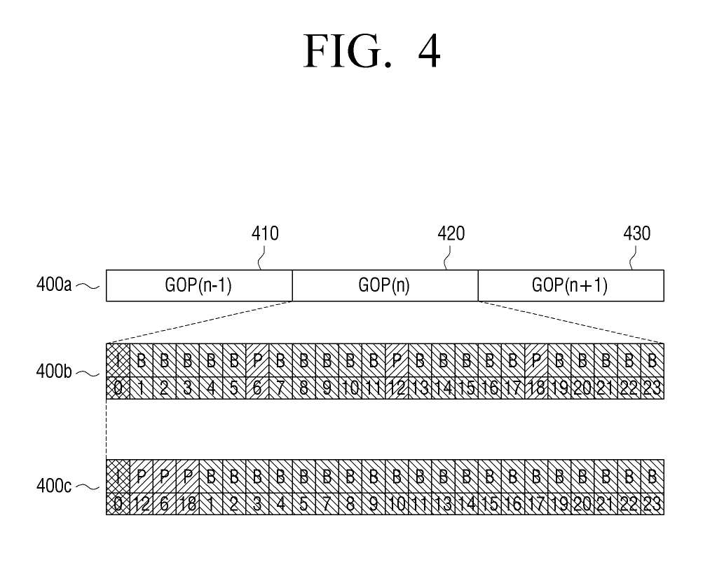

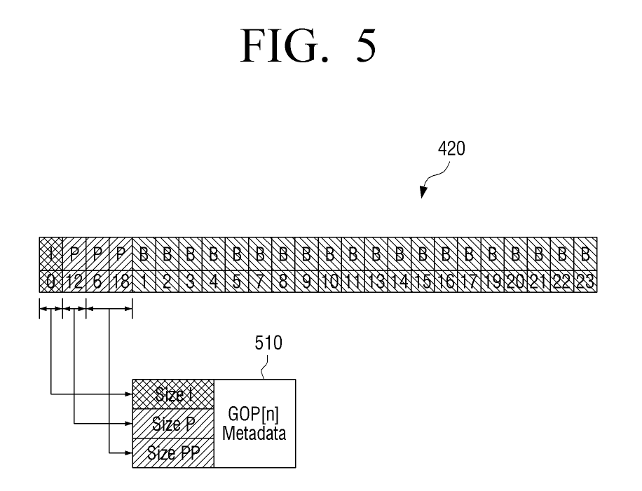

FIG. 4 is an exemplary diagram illustrating encoding image data based on a GOP according to an exemplary embodiment of the present inventive concept, and FIG. 5 is an exemplary diagram illustrating additional information of encoded image data according to an exemplary embodiment.

As shown in 400a of FIG. 4, image data of successive GOPs 410, 420 and 430 may be input into the storage medium 100 and each of the successive GOPs 410, 420, and 430 may consist of 24 frames. For example, an n^{th} GOP 420 consisting of 24 frames per 1 second may be decoded in a frame order as shown 400b. That is to say, the decoding may be performed such that B-frames, which are the 1^{st} to 6^{th} frames, are made between an I-frame, which is a 0^{th} frame and a P-frame which is a 6^{th} frame, B-frames, which are 7^{th} to 11^{th} frames are made between the P-frame which is the 6^{th} frame and a P-frame which is a 12^{th} frame, B-frames which are the 13^{th} to 17^{th} frames are made between the P-frame which is the 12^{th} frame and a P-frame which is an 18^{th} frame, and B-frames which are the 19^{th} to 23^{rd} frames are made after the P-frame as the 18^{th} frame.

The n^{th} GOP 420 having such a frame structure may be arranged and encoded in a decoding order so that the P-frames which are the 12^{th}, 6^{th}, 18^{th} frames are positioned after the I-frame which is a 0^{th} frame and the plurality of B-frames are positioned after the P-frame which is the 18^{th} frame, as shown in 400c, and then image data of the encoded n^{th} GOP 420 may be stored in the data area 120 of the storage medium 100.

Meanwhile when the n^{th} GOP 420 is encoded as shown in 400c, additional information 510 for the n^{th} encoded GOP 420 may be stored in the information storage area 110 of the storage medium 100. For example, the additional information 510 for the n^{th} encoded GOP 420 may include size information of the I-frame which is the 0^{th} frame, size information of the P-frame which is the 12^{th} frame, size information of the P-frames which is the 6^{th} and 18^{th} frames, and the structure information of the n^{th} GOP 420 as shown in FIG. 5. Here, the structure information of the n^{th} GOP 420 may include information of the number of B-frames between the I-frame as the 0^{th} frame and the P-frame as the 6^{th} frame, or the number of B-frames between the respective P-frames as described above in FIG. 4(b). Based on such a number of B-frames, the low data rate of the image data including the n^{th} GOP 420 may be predicted.

As shown in 400b of FIG. 4, in a case where the number of B-frames existing between the I-frame which is the 0^{th} frame and the P-frame which is the 6^{th} frame is five (5), the low data rate of the image data including the n^{th} GOP 420 may be six (6) which increases the number of B-frames, which is five (5), by one(1).

Such additional information of the n^{th} GOP 420 may include location information of the I-frame which is the 0^{th} frame. Therefore, in the high-speed replay for the image data including the n^{th} GOP 420 at the reproducing apparatus 300, the reproducing apparatus 300 may perform the high-speed replay in order a ×6, ×12 and ×24 data rate. That is to say, in the high-speed replay at the ×6 data rate, the reproducing apparatus 300 may sequentially decode and reproduce the I-frame which is the 0^{th} frame and the respective P-frames based on the size information of the I-frame and the respective P-frames and the location information of the I-frame included in the additional information of the n^{th} GOP 420. In other words, the reproducing apparatus 300 may perform the high-speed replay of the ×6 data rate by reproducing only four (4) frames (I-frame and three (3) P-frames) of 24 frames constituting the n^{th} GOP 420.

In the high-speed replay at the ×12 data rate, the reproducing apparatus 300 may sequentially decode and reproduce only the I-frame which is the 0^{th} frame and the P-frame which is the 12^{th} frame based on the size information of the I-frame and the P-frame which is the 12^{th} frame and the location information of the I-frame included in the additional information for the n^{th} GOP 420. That is to say, the reproducing apparatus 300 may perform the high-speed replay of the ×12 data rate by reproducing only two (2) frames (I-frame and the P-frame as the 12^{th} frame) of 24 frames constituting the n^{th} GOP 420.

In the high-speed replay at the ×24 data rate, the reproducing apparatus 300 may decode and reproduce only the I-frame which is the 0^{th} frame based on the size information and the location information of the I-frame included in the additional information for the n^{th} GOP 420. That is to say, the reproducing apparatus 300 may perform the high-speed replay of the ×24 data rate by reproducing only one frame (I-frame) of 24 frames constituting the n^{th} GOP 420.

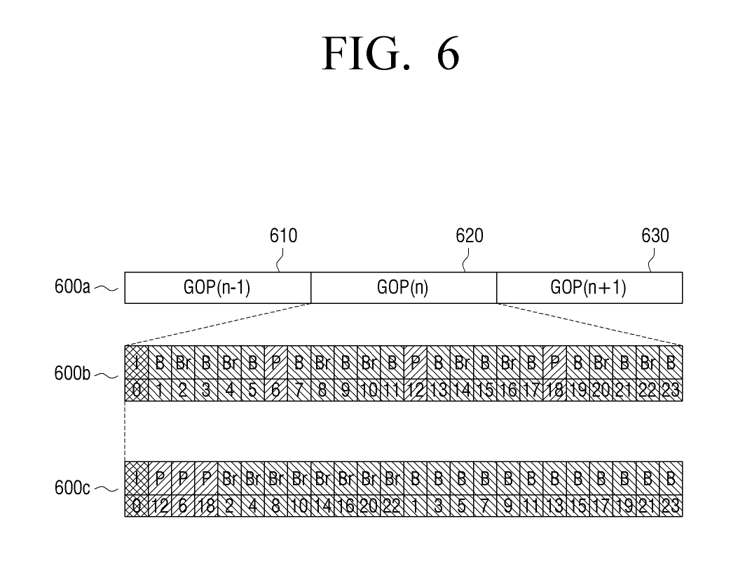

FIG. 6 is an exemplary diagram illustrating encoding image data based on a GOP according to another exemplary embodiment.

As shown in 600a of FIG. 6, image data based on successive GOPs 610, 620 and 630 may be input in the storage medium 100 and each of the successive GOPs 610, 620 and 630 may consist of 24 frames. That is to say, the decoding may be done such that B-frames which are the 1^{st} to 6^{th} frames are made between an I-frame which is a 0^{th} frame and a P-frame which is a 6^{th} frame, B-frames which are the 7^{th} to 11^{th} frames are made between the P-frame which is the 6^{th} frame and a P-frame which is a 12^{th} frame, B-frames which are 13^{th} to 17^{th} frames are made between the P-frame which is the 12^{th} frame and a P-frame which is an 18^{th} frame, and B-frames which are 19^{th} to 23^{rd} frames are made after the P-frame which is the 18^{th} frame.

In case of MPEG4, a B-frame as the two-way predictive frame may not only reference the I-frame or a P-frame positioned preceding the B-frame in time or may reference the I-frame or a P-frame located before and after the B-frame but may also reference a Br-frame as a reference B-frame located before and after the B-frame. Therefore, as shown at 600b of FIG. 6, there may be a Br-frame in the B-frames between an I-frame and a P-frame or in the B-frames between two P-frames. The n^{th} GOP 620 having such a structure of frames may be encoded so that the P-frames which are the 12^{th}, 6^{th}, and 18^{th} frames are positioned after the I-frame which is the 0^{th} frame and a plurality of Br-frames which are the 2^{nd}, 4^{th}, 6^{th}, 8^{th}, 10^{th}, 14^{th}, 16^{th}, 20^{th} and 22^{nd} frames are positioned after the P-frame as the 18^{th} frame, and thereafter the remaining B-frames are positioned in a decoded order, as shown in 600c of FIG. 6, and then may be stored in the data area 120 of the storage medium 100.

In this case, the additional information for the n^{th} GOP 620 may further include size information of the Br frames as well as size information of the I-frame which is the 0^{th} frame, size information of the P-frame which is the 12^{th} frame, size information of the P-frames which are the 6^{th} and 18^{th} frames, and structure information of the n^{th} GOP 420.

In a case where the Br-frames are further included, the reproducing apparatus 300 may perform a high-speed replay ranging from the low data rate of a double data rate to the high data rate of a ×24 data rate.

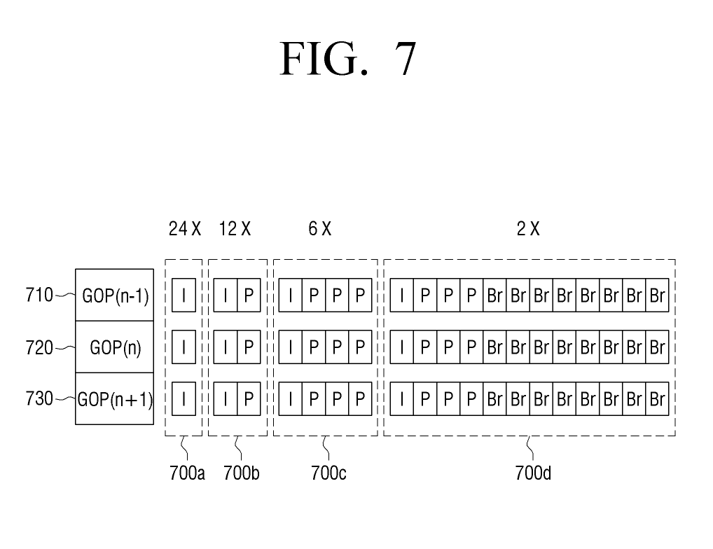

FIG. 7 is an exemplary diagram illustrating performing a high-speed replay at multiple data rates in the reproducing apparatus according to an exemplary embodiment.

As shown in FIG. 7, the reproducing apparatus 300 may perform the high-speed replay of image data including encoded GOPs 710, 720 and 730 at multiple data rates according to a data rate corresponding to a high-speed replay command. Each of the successive GOPs 710, 720 and 730 may consist of the 24 frames and may be encoded in order of an I-frame, P-frames and B-frames as described above. When a high-speed replay command with respect to image data including the encoded GOPs 710, 720, and 730 is input, the reproducing apparatus 300 may perform a high-speed replay at any data rate corresponding to the input high-speed replay command in response to the following input high-speed replay command.

The high-speed replay command corresponding to a high data rate may be input. As described above, the data rate corresponding to the high-speed replay may be a ×24 data rate in case where each of the successive GOPs 710, 720 and 730 consists of 24 frames. Therefore, when the high-speed replay command of the ×24 data rate, which is a high data rate, is input, the reproducing apparatus 300 sequentially decodes an I-frame of the (n−1)^{th} GOP 710, an I-frame of the n^{th} GOP 720 and an I-frame of the (n+1)^{th} GOP 730 with reference to size information and location information of the I-frame included in the respective additional information for the encoded GOPs 710, 720 and 730 as shown in 700a. Thereafter, the reproducing apparatus 300 sequentially reproduces image data with respect to the I-frame of the (n−1)^{th} decoded GOP 710, the I-frame of the n^{th} decoded GOP 720 and the I-frame of the (n+1)^{th} decoded GOP 730 and as a result may perform a high-speed replay the image data including the GOPs 710, 720 and 730 at the ×24 data rate.

When the high-speed replay command of a ×12 data rate is input, the reproducing apparatus 300 decodes the I-frame and a P-frame positioned after the I-frame of the (n−1)^{th} GOP 710, then the I-frame and a P-frame after the I-frame of the n^{th} GOP 720, and finally the I-frame and a P-frame after the I-frame of the (n+1)^{th} GOP 730 with reference to location information of the I-frame and size information of the I-frame and the P-frame positioned after the I-frame included in the respective additional information for the encoded GOPs 710 to 730 as shown in 700b. Thereafter, the reproducing apparatus 300 sequentially reproduces the image data with respect to the I-frame and the P-frame positioned after the I-frame of the (n−1)^{th} decoded GOP 720, the I-frame and the P-frame positioned after the I-frame of the n^{th} decoded GOP 720 and the I-frame and the P-frame positioned after the I-frame of the (n+1)^{th} decoded GOP 730. As a result, image data may be quickly replayed including the GOPs 710, 720 and 730 at the ×12 data rate.

In MPEG2, when each of the successive GOPs 710, 720, and 730 consists of 24 frames, the low data rate may be a ×6 data rate. Therefore, when the high-speed replay command for the ×6 data rate as the low data rate is input, the reproducing apparatus 300 decodes the I-frame and all P-frames of the (n−1)^{th} GOP 710, then the I-frame and all P-frames of the n^{th} GOP 720, and finally the I-frame and all P-frames of the (n+1)^{th} GOP 730 with reference to location information of the I-frame and size information of the I-frame and all of the P-frames positioned after the I-frame included in the respective additional information for the encoded GOPs 710, 720 and 730 as shown in 700c. Thereafter, the reproducing apparatus 300 sequentially reproduces the image data with respect to the I-frame and all of the P-frames of the (n−1)^{th} decoded GOP 720, the I-frame and all of the P-frames of the n^{th} decoded GOP 720 and the I-frame and all of the P-frames of the (n+1)^{th} decoded GOP 730 and as a result may quickly replay the image data including the GOPs 710, 720 and 730 at the low data rate of the ×6 data rate.

Meanwhile, in MPEG4, when each of the successive GOPs 710 to 730 consists of 24 frames, the low data rate may be a ×2 data rate. Therefore, when the high-speed replay command for the ×2 data rate as the low data rate is input, the reproducing apparatus 300 decodes the I-frame, all of the P-frames and all Br-frames of the (n−1)^{th} GOP 710, then the I-frame, all of the P-frames and all Br-frames of the n^{th} GOP 720, and finally the I-frame, all of the P-frames and all Br-frames of the (n+1)^{th} GOP 730 with reference to location information of the I-frame and size information of the I-frame, and all of the P-frames and all of the Br-frames positioned after the I-frame included in the respective additional information for the encoded GOPs 710, 720 and 730 as shown in 700d. Thereafter, the reproducing apparatus 300 sequentially reproduces the image data with respect to the I-frame, all of the P-frames and all of the B-frames of the (n−1)^{th} decoded GOP 720, the I-frame, all of the P-frames and all of the B-frames of the n^{th} decoded GOP 720, and the I-frame, all of the P-frames and all of the B-frames of the (n+1)^{th} decoded GOP 730. As a result, image data may be quickly replayed including the GOPs 710, 720 and 730 at the low data rate of the ×2 data rate.

Hereinafter, the operations of the reproducing apparatus 300 for reproducing image data which have been encoded and then stored will be described in detail.

FIG. 8 is a first exemplary diagram illustrating reproducing encoded image data in the reproducing apparatus according to an exemplary embodiment.

As shown in FIG. 8, the encoded image data of a GOP 810 consisting of 24 frames may be input into the reproducing apparatus 300. When such encoded GOP 810 is input, the reproducing apparatus 300 temporarily stores a plurality of frames constituting the inputted GOP 810 in a first buffer 360 in an order where the plurality of frames have been encoded.

According to an exemplary embodiment, the GOP 810 may be encoded in order of an I-frame, a plurality of P-frames and a plurality of B-frames. Therefore, the first buffer 360 may temporarily store the frames in order of the I-frame, the plurality of P-frames and the plurality of B-frames. As such, when the frames are temporarily stored in the first buffer 360, the controller 340 may control the decoder 320 such that the frames are decoded in an order in which the frames are to be reproduced, with reference to identification information of each frame. Pursuant to such control instructions, the decoder 320 performs the decoding of the plurality of frames temporarily stored in the first buffer 360, in an order where the frames are to be reproduced. That is to say, the decoder 320 sequentially performs the decoding of the frames, in order of an I-frame of a 0^{th} frame to a B-frame of a 23^{rd} frame and then outputs them to a second buffer 370. Accordingly, the second buffer 370 receives the decoded frames in an order in which the frames have been reproduced. In other words, the second buffer 370 may receive and temporarily store the frames sequentially decoded and outputted in order from the I-frame which is the 0^{th} frame to the B-frame which is the 23^{rd} frame and then outputs the frames to the display 330 in an order in which the frames were temporarily stored. As a result, the display 330 may display the image data in an order in which the frames are outputted from the second buffer 370.

FIG. 9 is a second exemplary diagram illustrating reproducing image data encoded in the reproducing apparatus according to another exemplary embodiment.

As shown in FIG. 9, the encoded image data of a GOP 910 consisting of 24 frames may be input to the reproducing apparatus 300. When such encoded GOP 910 is inputted, the reproducing apparatus 300 temporarily stores a plurality of frames constituting the input GOP 910 in the first buffer 360 in an order in which the plurality of frames have been encoded.

According to an exemplary embodiment, the GOP 810 may be encoded in order of an I-frame, a plurality of P-frames and a plurality of B-frames. Therefore, the first buffer 360 may temporarily store the frames in order of the I-frame, the plurality of P-frames and the plurality of B-frames. As such, when the frames are temporarily stored in the first buffer 360, the first buffer 360 outputs the plurality of frames to the decoder 320 in an order in which the frames have been temporarily stored. That is to say, the first buffer 360 may temporarily store the frames in order of the I-frame as a 0^{th} frame, a P-frame as a 12^{th} frame, a P-frame as a 6^{th} frame, a P-frame as a 18^{th} frame, and B-frames as 1^{st} to 23^{rd} frames and output them the decoder 320 in order where the frames have been temporarily stored.

Therefore, the decoder 320 performs the decoding of frames in an order in which the frames are outputted from the first buffer 360. That is to say, the decoder 320 may temporarily store and decode the frames in order of the I-frame as the 0^{th} frame, the P-frame as the 12^{th} frame, the P-frame as the 6^{th} frame, the P-frame as the 18^{th} frame, and the B-frames as 1^{st} to 23^{rd} frames and then output them to the second buffer 370 in order where the frames have been decoded. Accordingly, the second buffer 370 may temporarily store the frames in order where the frames have been decoded and outputted. As such, when the frames have been temporarily stored in the second buffer 370 in the decoded order, the controller 340 controls the second buffer 370 to display the frames, from a frame corresponding to a priority with reference to identification information of the plurality of frames.

Pursuant to such control instructions, the second buffer 370 outputs the frames to the display 330, from a frame corresponding to a priority in the plurality of frames temporarily stored in the second buffer 370. Specifically, the second buffer 370 outputs the plurality of decoded frames to the display 330 in order the I-frame as the 0^{th} frame to the B-frame as the 23^{rd} frame. Thus the display 330 may display the image data in order where the frames are outputted from the second buffer 370.

The respective configurations of the storage medium 100 for storing the image data and the reproducing apparatus 300 for reproducing the encoded image data according to the exemplary embodiments have been described in detail as indicated above. Hereinafter, methods for storing the image data in the storage medium 100 and reproducing the encoded image data in the reproducing apparatus 300 according to the exemplary embodiments are disclosed.

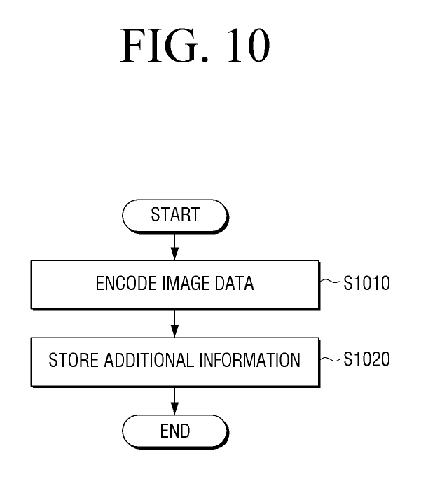

FIG. 10 is a flowchart illustrating a method for storing image data in a storage medium according to an exemplary embodiment.

As shown in FIG. 10, the storage medium 100 encodes the image data including at least one GOP (S1010). Then, the storage medium 100 stores the encoded image data and additional information for the corresponding image data (S1020).

Here, each of the at least one GOP includes an I-frame, a plurality of P-frames and a plurality of B-frames, and the plurality of frames included in each of the at least one GOP may be encoded in order of the I-frame, the plurality of P-frames and the plurality of B-frames and then stored in the data area.

Further, the additional information may include location information of the I-frame, size information of the I-frame and the plurality of P-frames, and structure information of the GOP. Here, the location information of the I-frame is start information showing where the I-frame begins to be reproduced, and the structure information of the GOP may be information for the number of B-frames between the I-frame and a P-frame or that of B-frames between two P-frames. Such additional information may be stored in the information storage area of the storage medium 100.

As described above, a B-frame which references the I-frame or a P-frame positioned before the B-frame or references the I-frame or a P-frame located before and after the B-frame may reference a specific B-frame under a predetermined condition. Here, the specific B-frame is a reference B-frame, and in case where there is such a reference B-frame, each of at least one GOP may be encoded in order of the I-frame, the plurality of P-frames, the reference B-frame, and the remaining B-frames and then stored in the data area.

As such, when there is a reference B-frame, the additional information including location information of the I-frame, size information of the I-frame and the plurality of P-frames, and structure information of the GOP may further include size information of the reference B-frame.

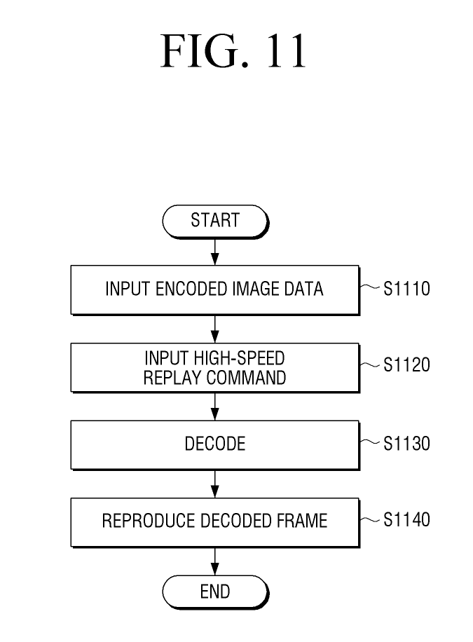

FIG. 11 is a flowchart illustrating a method for reproducing the image data in the reproducing apparatus according to an exemplary embodiment.

As shown in FIG. 11, the encoded image data whose at least one GOP has been encoded in order of an I-frame, a plurality of P-frames and a plurality of B-frames is input to the reproducing apparatus 300 (S1110). Then, when a high-speed replay command is input, the reproducing apparatus 300 decodes at least one of the inputted I-frame and the plurality of inputted P-frames according to a data rate corresponding to the input high-speed replay command (S1120), and then the at least one of the inputted I-frame and the plurality of inputted P-frames are decoded (S1130). Afterwards, the reproducing apparatus 300 displays at least one of the decoded I-frame and the plurality of decoded P-frames (S1140).

Specifically, the reproducing apparatus 300 may decode at least one of the I-frame and the plurality of P-frames according to the data rate corresponding to the high-speed replay command based on the additional information for the encoded image data. Here, the additional information may include location information of the I-frame for at least one of respective GOPs, size information of the I-frame and the plurality of P-frames, and structure information of the GOP. Here, the location information of the I-frame is start information showing where the I-frame begins to be reproduced, and the structure information of the GOP may be information for the number of B-frames between the I-frame and a P-frame or that of B-frames between two P-frames.

Accordingly, the reproducing apparatus 300 may decode at least one of the I-frame and the plurality of P-frames based on the additional information with respect to the pre-stored corresponding image data, and then may display the decoded frame.

According to an exemplary embodiment, when the high-speed replay command corresponding to a high data rate is input, the reproducing apparatus 300 decodes only the I-frame based on the location information of the I-frame and the size information of the I-frame with reference to the additional information. As such, when the I-frame is decoded with respect to each GOP, the reproducing apparatus 300 may perform the high-speed replay corresponding to the high data rate by displaying the I-frame in the respective decoded GOP.

When the high-speed replay command corresponding to a low data rate is input, the reproducing apparatus 300 decodes the I-frame and the plurality of P-frames based on the location information of the I-frame and the size information of the I-frame and the plurality of P-frames with reference to the additional information. As such, when the I-frame and the plurality of P-frames of each GOP have been encoded, the reproducing apparatus 300 may perform the high-speed replay corresponding to the low data rate by displaying the image data only with respect to the I-frame and the plurality of P-frames in the respective decoded GOP.

When the high-speed replay command corresponding to an intermediate data rate between the high and the low data rate is input, the reproducing apparatus 300 decodes only the I-frame and a P-frame positioned after the I-frame based on the location information of the I-frame and the size information of the I-frame and the P-frame positioned after the I-frame with reference to the additional information. As such, when the I-frame with respect to respective GOP and the P-frame positioned after the I-frame have been decoded, the reproducing apparatus 300 may perform the high-speed replay corresponding to the intermediate data rate by displaying the image data only with respect to the I-frame and the P-frame positioned after the I-frame for the respective decoded GOP.

The foregoing exemplary embodiments are merely exemplary and should not be construed as limiting the inventive concept. Also, the description of the exemplary embodiments of the present inventive concept is intended to be illustrative, and not to limit the scope of the claims, and many alternatives, modifications, and variations will be apparent to those skilled in the art.

What is claimed is:

1. A method of storing image data, the method comprising:
encoding image data comprising at least one group of pictures (GOP); and
storing the encoded image data and additional information for the image data,
wherein the at least one GOP comprises an intra-frame (I-frame), a plurality of predictive-frames (P-frames) and a plurality of bi-directionally predictive frames (B-frames); and
wherein the encoding the image data comprises encoding the at least one GOP in order of the I-frame, the plurality of P-frames and the plurality of B-frames.

2. The method of claim 1, wherein the additional information comprises location information of the I-frame, size information of the I-frame, size information of the plurality of P-frames, and structure information of the at least one GOP.

3. The method of claim 1, wherein in response to the at least one GOP comprising a reference B-frame in the plurality of B-frames, the reference B-frame is encoded so as to be positioned before the other B-frames of the plurality of B-frames, and
wherein the reference B-frame is a reference frame for the plurality of B-frames other than the reference B-frame.

4. The method of claim 3, wherein the additional information comprises location information of the I-frame, size information of the I-frame, size information of the plurality of P-frames, size information of the reference B-frame, and structure information of the at least one GOP.

5. A method of reproducing image data, the method comprising:
receiving image data comprising at least one group of pictures (GOP), wherein the at least one GOP is encoded in an order of an intra-frame (I-frame), a plurality of predictive-frames (P-frames) and a plurality of bi-directionally predictive frames (B-frames);
in response to a high-speed replay command, decoding at least one of the I-frame and the plurality of P-frames according to a data rate which corresponds to the high-speed replay command; and
reproducing at least one of the decoded I-frame and the plurality of decoded P-frames.

6. The method of claim 5, wherein the decoding comprises decoding at least one of the I-frame and the plurality of P-frames according to a data rate, which corresponds to the high-speed replay command, based on additional information for the encoded image data; and
wherein the additional information comprises location information of the I-frame, size information of the I-frame, size information of the plurality of P-frames, and structure information of GOP.

7. The method of claim 6, wherein the decoding comprises, in response to a high-speed replay command which corresponds to a high data rate, decoding only the I-frame based on the location information of the I-frame and the size information of the I-frame.

8. The method of claim 6, wherein the decoding comprises, in response to a high-speed replay command which corresponds to a low data rate, decoding the I-frame and the plurality of P-frames based on the location information of the I-frame, the size information of the I-frame, and the size information of the plurality of P-frames.

9. The method of claim 6, wherein the decoding comprises, in response to a high-speed replay command corresponding to an intermediate data rate, decoding the I-frame and a P-frame positioned after the I-frame based on the location information of the I-frame, the size information of the I-frame, and the size information of the P-frame positioned after the I-frame.

10. A storage medium configured to store image data, the storage medium comprising:
an information storage area configured to store additional information for the image data; and
a data area configured to store image data comprising at least one group of pictures (GOP),
wherein each of the at least one GOP comprises an intra-frame (I-frame), a plurality of predictive-frames (P-frames) and a plurality of bi-directionally predictive frames (B-frames), and
wherein the at least one GOP is encoded in an order of the I-frame, the plurality of P-frames, and the plurality of B-frames.

11. The storage medium of claim 10, wherein the additional information comprises location information of the I-frame, size information of the I-frame, size information of the plurality of P-frames, and structure information of the GOP.

12. The storage medium of claim 10, wherein in response to there being a reference B-frame, which serves as a reference frame for the plurality of B-frames other than the reference B-frame, in the plurality of B-frames, the reference B-frame is encoded so as to be positioned before the other B-frames of the plurality of B-frames.

13. The storage medium of claim 12, wherein the additional information comprises location information of the I-frame, size information of the I-frame, size information of the plurality of P-frames, size information of the reference B-frame, and structure information of the GOP.

14. An apparatus configured to reproduce image data, the apparatus comprising:
an inputter configured to receive image data comprising at least one group of pictures (GOP) which are encoded in an order of an intra-frame (I-frame), a plurality of predictive-frames (P-frames) and a plurality of bi-directionally predictive frames (B-frames);
a decoder configured to decode the encoded image data;
a display configured to display the decoded image data; and
a controller configured to control the decoder to decode at least one of the I-frame and the plurality of P-frames according to a data rate corresponding to a high-speed replay command, and control the display to display image data with respect to at least one of the decoded I-frame and the plurality of decoded P-frames, respectively, in response to the high-speed replay command.

15. The apparatus of claim 14, wherein the controller is configured to control the decoder to decode at least one of the I-frame and the plurality of P-frames according to a data rate which corresponds to the high-speed replay command based on additional information for the encoded image data; and
wherein the additional information comprises location information of the I-frame, size information of the I-frame, size information of the plurality of P-frames, and structure information of the GOP.

16. The apparatus of claim 15, wherein the controller is configured to control the decoder to decode only the I-frame based on the location information of the I-frame and the size information of the I-frame, in response to a high-speed replay command corresponding to a high data rate.

17. The apparatus of claim 15, wherein the controller is configured to control the decoder to decode the I-frame and the plurality of P-frames based on the location information of the I-frame, the size information of the I-frame, and the size information of the plurality of P-frames, in response to a high-speed replay command corresponding to a low data rate.

18. The apparatus of claim 15, wherein the controller is configured to control the decoder to decode the I-frame and a P-frame positioned after the I-frame based on the location information of the I-frame and the size information of the I-frame and the P-frame positioned after the I-frame, in response to a high-speed replay command corresponding to an intermediate data rate input.

19. The apparatus of claim 14, further comprising:
a first buffer configured to temporarily store frames which are output from the inputter; and
a second buffer configured to temporarily store frames which are output from the decoder and configured to output the temporarily stored frames to the display,
wherein the controller is configured to control the decoder to perform the decoding according to a priority based on identification information for each of the frames which are temporarily stored in the first buffer.

20. The apparatus of claim 14, further comprising:
a first buffer configured to temporarily store frames which are output from the inputter; and
a second buffer configured to temporarily store frames which are output from the decoder and configured to output the temporarily stored frames to the display;
wherein the controller is configured to control the second buffer to display the frames, according to a priority based on identification information for each of the frames which are temporarily stored in the second buffer.
